(19) United States
(12) Patent Application Publication
(10) Pub. No.: US 2007/0131308 A1
(43) Pub. Date: Jun. 14, 2007

(54) Method of manufacturing a timber frame structural panel assembly, and timber frame structural panel assembly

(76) Inventor: Gerald Martin, Condover (GB)

Correspondence Address: PEDERSEN & COMPANY, PLLC, P.O. BOX 2666, BOISE, ID, 83701, US

(21) Appl. No.: 11/509,792

(22) Filed: Aug. 23, 2006

(30) Foreign Application Priority Data
Aug. 24, 2005 (GB) 0517295.2
Dec. 30, 2005 (GB) 0526585.5
Jun. 27, 2006 (GB) 0612665.0

(51) Int. Cl. B27F 7/00

(52) U.S. Cl. 144/344

(57) ABSTRACT

This invention relates to a method of manufacturing a timber frame structural panel assembly, and to a timber frame structural panel assembly. The invention firstly provides a method of making a panel assembly comprising a framework of timber beams, at least one sheet of sheathing material and a breather membrane, all of which are secured together in a single fixing operation. The invention secondly provides a panel assembly comprising two panel structures, each panel structure comprising a pair of sheathing panels with a layer of insulating material therebetween, the panel structures being joined by a beam of timber which engages the sheathing panels of both panel structures and is secured thereto by a single line of wide crown staples.

### FIELD OF THE INVENTION

This invention relates to a method of manufacturing a timber frame structural panel assembly, and to a timber frame structural panel assembly. The invention relates in particular to a method of making a timber frame structural panel assembly which is to be used as a structural panel for a building such as a domestic dwelling.

### BACKGROUND OF THE INVENTION

Buildings such as domestic dwellings are often constructed with the inner or structural wall made from timber frame structural panel assemblies. The panel assemblies are usually constructed at dedicated facilities away from the site of construction of the building.

A first type of panel assembly is constructed from a framework of timber planks or beams (typically referred to as rails and studs), to which is fixed one or more sheets of plywood or other suitable material (such as oriented strand board—“OSB”—for example), these sheets being referred to as “sheathing” or “cladding”. The sheathing provides much of the structural strength of the assembled panel by resisting shearing or racking forces upon the panel.

A breather membrane is then fitted over the sheathing, the breather membrane typically being secured to the sheathing by staples or the like.

During construction of the building, the required number of panel assemblies will first be erected, and will then typically be covered by an external layer of bricks to provide weatherproofing for the building. The builder will join the layer of bricks to the timber frame of the building by way of timber to brick wall ties positioned at intervals, and the manufacturer of the panel assemblies will typically apply marker tape onto the breather membrane as a final assembly step to mark the location of the studs within the panel so that the wall ties can be fixed through the breather membrane and sheathing and into solid timber.

Panel assemblies which are constructed in the above-described way, namely from a framework of timber planks or beams, sheets of plywood or the like, a breather membrane, and lengths of marker tape, is a first type of panel assembly which is referred to herein as a “timber frame structural panel assembly”, or more simply hereafter as a “panel assembly”.

The conventional method of assembling this first type of panel assembly is to arrange the timber rails and studs into their desired formation upon a workbench and to nail these together. They may also be manufactured by purpose-designed machines. The sheathing is then laid over the framework of rails and studs and nailed thereonto (it is also known to use narrow crown staples to secure the sheathing, but nails are preferred by most panel manufacturers). The breather membrane is then laid over the sheathing and is stapled onto the sheathing. The marker tape is then laid over the breather membrane and located over the studs and is stapled to the sheathing through the membrane as a final assembly step.

It will be understood that following assembly of the timber framework, there are three separate operations, respectively to secure the sheathing, the breather membrane and the marker tape, including one nailing operation and two separate stapling operations. Care must be taken during the second of these operations to ensure that the fixings for the breather membrane do not foul any of the previously-fitted fixings for the sheathing, since the previously-fitted fixings will be obscured by the breather membrane (and similarly during the third of these operations as the marker tape will obscure the underlying fixings for the sheathing and breather membrane).

Attempts have been made to reduce the number of operations, in particular by combining the two stapling operations into one by locating the marker tape over the breather membrane before the breather membrane has been secured, and stapling the marker tape and breather membrane to the sheathing at the same time.

Staples are typically used to secure the breather membrane and marker tape as they provide better securement of these flexible and tearable materials than would nails or the like. Since the breather membrane and marker tape are relatively light the staples do not need to be large, and the staples which are typically used are “narrow crown staples”, i.e. those in which the staple legs are separated by a to distance of around 12 mm or less.

A second type of timber frame structural panel assembly is that type commonly referred to as a structural insulated panel. This type of panel assembly in general comprises two layers of sheathing material, usually OSB, between which is located a layer of insulation material, usually urethane or similar foam. The foam layer performs the dual functions of providing adhesion to the sheathing panels and providing insulation to the assembled panel.

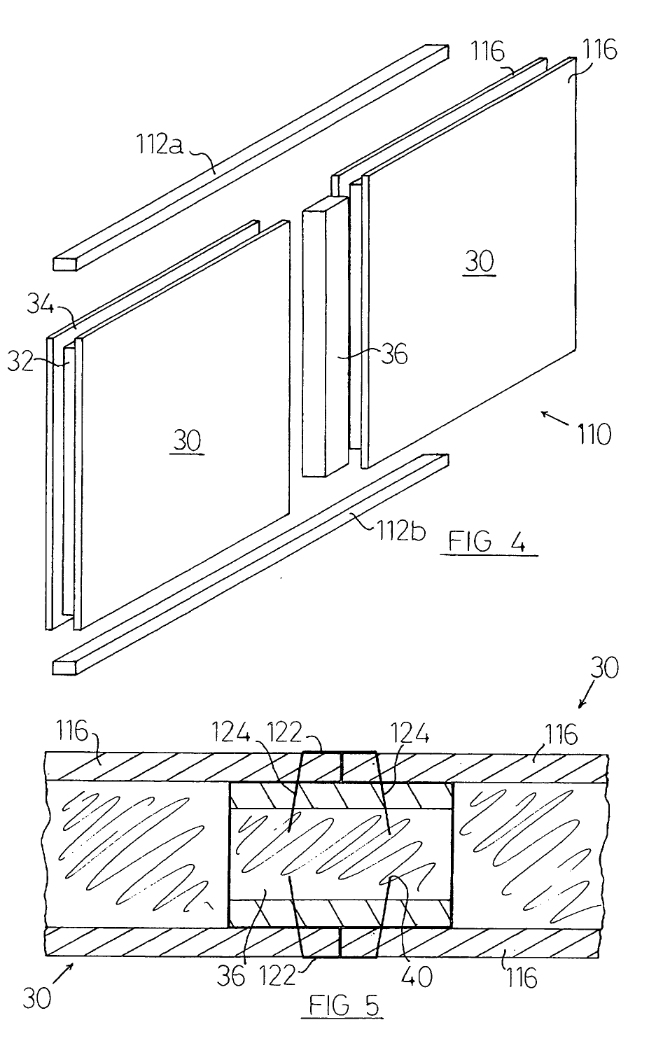

FIG. 4 of the accompanying drawings shows a typical assembly 110 of two structural insulated panels 30. The two structural insulated panels 30 are substantially identical in this embodiment, and each comprise two sheathing panels 116, in this example OSB, which are secured together by the intervening urethane foam layer 32. The area of the sheathing panels 116 is slightly larger than the area of the foam layer, so that a channel 34 exists around the periphery of the foam layer 32.

A number of beams or planks of timber or the like are located in the channel 34 so as to complete the assembly 30. A first beam 112a provides the top rail (sometimes also called the head plate), a second beam 112b provides the bottom rail (sometimes also called the sole rail or bottom plate), and it will be noted that these beams engage the channel 34 of both panels 30 and so act to secure the panels 30 together.

Notwithstanding that the beams 112a,b act to secure the panels together, the main joint between the panels 30 is provided by the beam 36, which lies in the parts of the channels 34 of each panel 30 which face each other. The beam 36 can be of timber but is typically also a sandwich of two timber or similar material layers and a foam insulation layer. The sheathing panels 116 of each panel 30 are abutted over the beam and are then secured to the beam 36, thereby securing the sheathing panels 116 and the panels 30 to each other.

Beams of timber or other material are typically secured to the opposed ends of the panels 30 so as to complete the assembled structural insulated panel.

### SUMMARY OF THE INVENTION

It is an object of the present invention to seek to reduce further the number of steps involved in manufacturing a timber frame structural panel assembly.

According to the first aspect of the invention there is provided a method of making a timber frame structural panel assembly comprising the following steps:
(i) preparing and assembling a framework of timber beams or planks;
(ii) locating at least one sheet of sheathing material over the framework;
(iii) locating a breather membrane over the sheathing; and
(iv) inserting a number of fixing members through the breather membrane and sheathing material and into a respective part of the framework so as to secure the breather membrane and sheathing together to the framework.

According to this aspect of the invention therefore, a panel assembly of the first type is made with the sheathing material being secured to the framework at the same time as the breather membrane. This has the advantage that the fixing members which are used to secure the sheathing to the framework remain visible and are not hidden by the breather membrane as in the conventional assembly method. The location of the studs in particular is therefore visible without requiring marker tape, and a timber frame structural panel assembly can be made according to the invention without the marker tape required with conventional methods. If, however, it is preferred to use marker tape then the series of steps can include the additional step of locating marker tape before the fixing members are inserted to secure the breather membrane and sheathing (and marker tape) together to the framework. Despite the possible absence of marker tape, the above stated definition of the first type of timber frame structural panel assembly will nevertheless be used for such panel assemblies.

This method has the additional advantage that there is no danger of a fixing fouling a previously-fitted fixing which has subsequently been obscured from view, since all of the fixings remain visible in the finished panel assembly.

Another advantage of the fixing members of the sheathing remaining visible in the finished panel assembly is that customers can verify for themselves that the required number and disposition of the fixing members has been used, it being understood that the number and disposition of fixing members for the sheathing has a significant bearing upon the structural strength of the panel assembly. Thus, before a panel assembly is fitted to the frame of a building a visual check can be undertaken upon the number and disposition of the fixing members.

Ideally, the fixing members are staples, preferably “wide crown staples”, which are herein defined as staples having a separation between the staple legs of around 20 to 30 mm. The inventor has therefore realised that wide crown staples can be used to secure the sheathing to the framework, in place of the conventional nails.

It will be understood that the crown of a wide crown staple remains readily visible after insertion, so that a line of wide crown staples in the breather membrane will readily identify the location of the timbers of the framework therebelow.

The use of staples to secure the sheathing has another advantage in that where two sheathing panels meet over a stud (the stud where two sheating panels meet hereinafter being called a “joining stud”) a single line of staples can be used to secure both sheathing panels to the joining stud, with one leg of each staple securing one of the panels and the other leg of each staple securing the other of the panels. In conventional methods two lines of nails would be required, one line for each panel.

There is also provided a panel assembly manufactured according to the method, and comprising a framework of timbers, a layer of sheathing, a layer of breathable membrane, the breathable membrane and the sheathing being secured to the framework by common fixing members.

A similar method can be utilised on the second type of panel assembly, namely structural insulated panels. As indicated above, structural insulated panels in general comprise two layers of sheathing material between which is located a layer of insulation material. Structural insulated panels can be joined together and used for example in the construction of load bearing walls and roof panels, and have the advantages of high strength to weight ratio and good insulation characteristics.

A structural insulated panel will typically be constructed with the sheathing panels extending slightly beyond the foam layer. This allows beams of timber or the like to be fitted around the foam layer to complete the panel, or perhaps to complete an assembly of several individual panels.

It has been appreciated that wide crown staples can be used to secure the panels to the beams, and a single line of staples can be used across the line of abutment of the adjacent sheathing panels, in place of two separate lines of nails, so reducing the number of manufacturing steps.

Therefore, according to the second aspect of the present invention, there is provided a method of making a timber frame structural panel assembly comprising the following steps:
(i) preparing a first panel structure comprising two first sheathing panels with a first layer of insulating material therebetween, the layer of insulating material being secured to both of the sheathing panels, and the edges of the sheathing panels extending beyond the edges of the layer of insulating material to provide a first channel along at least one edge of the panel structure;
(i) preparing a second panel structure comprising two second sheathing panels with a second layer of insulating material therebetween, the layer of insulating material being secured to both of the sheathing panels, and the edges of the sheathing panels extending beyond the edges of the layer of insulating material to provide a second channel along at least one edge of the panel structure;
{iii} locating a beam of timber into both of the first channel and the second channel and moving the first panel structure and second panel structure together so that the edges of each of the first sheathing panels and the second sheathing panels overlie the beam of timber; and
(iv) inserting a line of wide crown staples through the sheathing panels and into the beam of timber, the staples each having a first leg and a second leg, the first leg passing through a first sheathing panel and into the beam of timber and the second leg passing through a second sheathing panel and into the beam of timber.

Preferably, the respective edges of the first sheathing panel and the second sheathing panel abut over the timber beam. Preferably also, the beam of timber engages the first and the second layers of insulating material.

It has also been appreciated that by shaping the leading ends of the staples, the legs of the staples (which are initially substantially parallel) can be forced out of parallel (i.e. to converge or diverge) upon entry into the sheathing and beam material, such convergence or divergence acting to increase the force required to remove the staples. Staples with legs shaped in this way can be used with the method according to the first or second aspect of the present invention.

### BRIEF DESCRIPTION OF THE PREFERRED EMBODIMENTS

The invention will now be described in more detail, by way of example, with reference to the accompanying drawings, in which:

FIG. 1 shows a schematic plan view of a panel assembly constructed according to the method of the first aspect of the present invention;

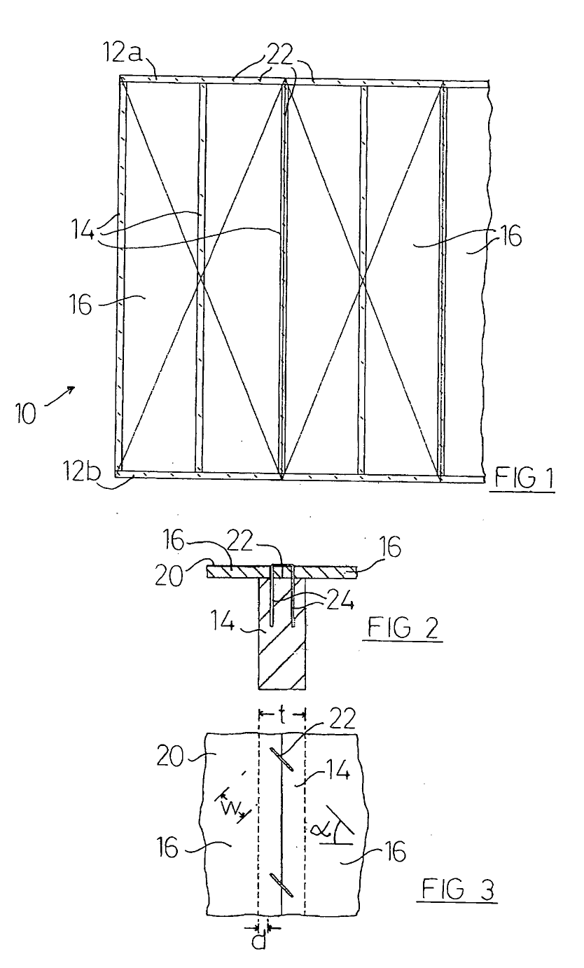

FIG. 2 shows a sectional view through a stud of a panel assembly of FIG. 1;

FIG. 3 shows a plan view of part of the panel assembly of FIG. 1;

FIG. 4 shows a perspective exploded view of components of a panel assembly prior to construction according to the second aspect of the present invention, and

FIG. 5 shows a sectional view of the joint between the panel structures according to the second aspect.

### DETAILED DESCRIPTION

The panel assembly 10 comprises a framework of beams or planks of timber of conventional dimensions. In conventional nomenclature, the framework comprises a top rail 12a, a bottom rail 12b and a number of studs 14. It will be understood that other frameworks can include additional timbers between adjacent studs, if required or desired.

The sheathing comprising a number of panels 16 of plywood, OSB or the like is laid onto the framework, the panels 16 being represented by the diagonal lines of FIG. 1.

The studs 14 are of a length slightly less than the length of the panels 16, and specifically the length of the panels 16 is substantially the same as the length of the studs 14 plus the width of the top rail 12a and bottom rail 12b, as shown in FIG. 1. Also, the studs 14 are separated by a distance slightly less than half the width of the panels 16, so that the panels can be laid onto the framework as shown, with two adjacent panels 16 abutting over a stud 14.

The panel assembly is completed by a layer of breather membrane 20 (see FIG. 2; the breather membrane is shown as transparent in FIG. 1 so that the sheathing and studs are visible) which overlies the panels 16 (and therefore also the framework), and then a series of wide crown staples 22 are inserted through the breather membrane 20 and panels 16 and into the rails 12a, 12b and studs 14 to secure all of the parts together.

It will be observed that the line of staples 22 which are inserted into each of the joining studs 14 (i.e. the two studs shown which are engaged by the edges of two adjacent panels 16) have one of their legs passing through one of the panels 16 and the other of the legs passing through the other panel 16. In this way, a single line of staples 22 can be used to secure both of the panels 16 to a joining stud 14.

It will also be observed (in FIG. 3) that the staples are located at an angle α to the cross-sectional plane of the joining stud 14 into which they are inserted (i.e. at an angle 90°—α to the longitudinal axis of the joining stud). The angle α is chosen dependent upon the width w of the crown of the staple as compared to the thickness t of the joining or other stud 14, as applicable, it being desired that the legs 24 (FIG. 2) of the staple 22 lie at a chosen distance d away from the edge of the stud, so as to reduce the likelihood of the staple damaging the edge of the stud during insertion thereinto. Also, in the case of the staples at a joining stud 14 such as that of FIGS. 2 and 3, each leg 24 is at a distance approximately t/2-d from the edge of the respective panel 16, this distance being chosen to reduce the likelihood of the staple damaging the edge of the panel during insertion thereinto. Damage to the edge of a stud or rail and/or damage to the edge of a panel during insertion of a staple might reduce the strength of the connection between the panel 16 and the stud 14. If different staples are used, or different thickness studs and/or rails are used, so that the crown width is smaller relative to the thickness t of the stud 14, then the angle α could be reduced accordingly (and vice versa). A similar angled insertion of the staples into the top and bottom rails 12a,b is utilised as shown in FIG. 1, for the same reason.

It will be noted that in the embodiment of FIG. 1 all of the staples 22 are located at substantially the same angle α, i.e. the crowns of all of the staples are substantially parallel). During tests to check the shear or racking strength of panel assemblies such as those of FIGS. 1-3 it has been found that the resistance to racking is greater in one direction that the other, i.e. it is easier to move the top rail 12a of the panel shown in FIG. 1 to the left relative to the bottom rail 12b than it is to move the top rail to the right relative to the bottom rail. It is believed that this is due to the orientation of the staples 22 along the joining studs 14, in that when the top rail 12a is forced to the right the staples along the joining studs act to force the edges of the adjacent panels 16 together and the racking force is opposed by the friction between the edges of the panels 16. On the other hand, when the top rail 12a is forced to the left the staples along the joining studs 14 act to separate the edges of the adjacent panels 16.

To meet the racking loads specified for structural panels it would be possible to increase the number of staples, i.e. to reduce the distances between the staples, particularly those staples along a joining stud. Alternatively, the angle of the staples along the joining studs can be varied.

In particular, some of the staples on the joining studs 14 can be arranged at a first angle relative to the top and bottom rails, and other of the staples can be arranged at a second angle relative to the top and bottom rails.

Preferably, around half of the staples along the joining stud(s) are arranged at the first angle and the remainder are arranged at the second angle. Desirably but not necessarily, the first angle is opposed to the second angle, i.e. if the first angle is 30° for example then the second angle is 150° (i.e. 180°−30°).

The ideal situation is believed to be with around half of the staples located at an angle α of around 45°, and the remainder of the staples at an angle α of around 135°. This has the additional advantage that the staples at differing angles are substantially perpendicular to one another.

Also, the angle of the staples can alternate, i.e. the first, third etc, staples along the joining stud being arranged at the first angle and the second, fourth etc. staples are arranged at the second angle, or the staples can be arranged in groups of two, three, four etc. or more staples at a first angle followed by a similar group at a second angle, repeated along the joining stud.

Arranging the staples at differing angles need not be restricted to the joining stud, and a similar arrangement can be utilised along the other studs 14 and/or the rails 12, but it is expected that the greatest advantage in providing differently-angled staples will be achieved along the joining stud(s).

It will be observed that the line of staples 22 is easily visible in the panel assembly 10, so that the location of each timber, and in particular each stud 14, is clearly indicated, without the requirement for marker tape. If, however, marker tape is desired then this can be laid over the breather membrane prior to insertion of the staples 22.

It will also be observed that the distance between adjacent staples in the embodiment of FIG. 1 is smaller along certain of the studs 14 (i.e. along the joining studs and the stud at the end of the panel assembly) and along the rails, than along the remaining studs. It can be determined by calculation or experiment which are the areas of the panel assembly which suffer the greatest loads when the panel is under shear loading, and the distance between adjacent staples can be reduced in those areas (and similarly increased in the areas of lowest loading). In addition, if desired a particular spacing between adjacent staples along the joining studs can be used also to identify the joining studs, so that the building constructor is made aware of the locations of the edges of the sheathing panels despite those edges being obscured by the breather membrane.

The direct joining together of the adjacent panels by way of the staples is believed to be one possible reason for the increased structural rigidity for the assembled panels provided by the present invention. Thus, in tests on structural panels such as those described which have been constructed according to the invention, if staples are used substantially in direct replacement for nails the resistance to racking increases significantly. In particular, in some tests the bottom rail 12b broke before the sheathing panels 16 were forced away from the studs 14, so that the optimum strength of the panel assembly has been attained, and further staples or other fixings will not increase the resistance to racking. In fact, it has been realised that the number of staples can be reduced whilst keeping the resistance to racking above the required industry standard.

It has also been realised that the staples 22 fitted along the bottom or sole rail 12b play a disproportionate part in the resistance to racking, so that the spacing between staples in other parts of the panel assembly 10 can be increased whilst keeping the resistance to racking above the required industry standard.

It will be understood that sheathing is usually affixed to one side only of the framework, but “closed” panel assemblies are known in which sheathing providing structural strength is applied to one side of the framework and inner cladding such as non-load-bearing plaster board is applied to the other side of the framework (the “other side” lying internally of the building in use), so that the rails and studs are enclosed between the sheets of sheathing and inner cladding. If such closed panels are required, the inner cladding can be applied to the framework as an initial or final manufacturing step.

In addition, it is known to use sheathing boards which are made from a waterproof material such as cement particle board or similar proprietary products. In these applications, a separate breather membrane is not required, but a method similar to that defined in the invention according to the present claims could nevertheless still be used, taking advantage of the fact that the wide crown staples could be economically used to secure two adjacent sheathing boards to a stud, in place of the conventional two lines of nails.

FIGS. 4 and 5 show an embodiment of the invention according to its second aspect. In this embodiment the beam 36, which is often referred to as a spline or jointing beam, is secured to each of the sheathing panels 116, and consequently to each of the panels 30, by way of a single line of wide crown staples 122. The staples are preferably angled, and ideally arranged at varying angles, as described in relation to the embodiment of FIGS. 1-3.

The staples bridge the joint line between the adjacent sheathing panels 116 (the adjacent sheathing panels typically abutting along the joint line as shown in FIG. 5), so that one line of staples 122 can replace two lines of nails as typically used in prior art arrangements. Accordingly, the two sheathing panels 116, and therefore the two panel structures 30, are joined together not only indirectly by way of the beam 36, but also directly by each of the staples 122.

FIG. 5 shows another advantageous aspect, namely that the legs 124 of the staples 122 can be made to diverge upon entry into the material of the sheathing panels 116 and beam 36. Traditionally, the leading ends 40 of the legs of a wide crown staple are symmetrical and angled equally from both sides, so that the leg of the staple would follow a substantially linear path upon entry into the material and the legs would remain substantially parallel. However, if the legs are angled only on the inside they can be forced to diverge upon entry into the material as shown in FIG. 5, or if they are angled only on the outside they can be forced to converge upon entry into the material.

It is believed that staples which diverge or converge upon entry into the material will require a greater force to remove, and may therefore contribute more to resisting the racking load of an assembled panel.

Though not shown in the drawings, the ends 40 of the legs 124 of the staple 122 in the embodiment of FIG. 5 are angled only on the inside, so that they have been caused to diverge upon entry into the sheathing panels 116 and beam 36. There is an adequate width of material to accommodate this divergence, but if the width of the beam 36 was less the legs 124 could be caused to converge, reducing the likelihood of one or both of the legs breaking through the edge of the beam.

1. A method of making a timber frame structural panel assembly comprising the following steps:
(i) preparing and assembling a framework of timber beams;
(ii) locating at least one sheet of sheathing material over the framework;
(iii) locating a breather membrane over the sheathing; and
(iv) inserting a number of fixing members through the breather membrane and sheathing material and into a respective part of the framework so as to secure the breather membrane and sheathing together to the framework.

2. The method according to claim 1 including the additional step of locating marker tape over a selected part of the membrane after step (iii) and before step (iv).

3. The method according to claim 1 in which the fixing members are wide crown staples.

4. The method according to claim 3 in which a single line of staples is used to secure two sheathing panels to a single beam, with one leg of each staple securing one of the panels and the other leg of each staple securing the other of the panels.

5. The method according to claim 4 in which the staples are inserted to lie at an angle to the cross-sectional plane of the beam.

6. The method according to claim 5 in which the angle is determined according to the thickness of the beam and the width of the staples.

7. The method according to claim 5 in which respective staples are arranged at different angles relative to a beam.

8. A panel assembly comprising a framework of timber beams, a layer of sheathing, a layer of breathable membrane, the breathable membrane and the sheathing being secured to the framework by common fixing members.

9. A panel assembly according to claim 8 in which the fixing members are wide crown staples, in which the staples lie at an angle to the cross-sectional plane of a beam, and in which the angular orientation of some of the staples in a panel differs from the angular orientation of other of the staples in the panel.

10. A panel assembly according to claim 8 in which the spacing between adjacent fixing members varies between different areas of the panel assembly.

11. A method of making a timber frame structural panel assembly comprising the following steps:
(i) preparing a first panel structure comprising two first sheathing panels and a first layer of insulating material therebetween, the layer of insulating material being secured to both of the sheathing panels, and the edges of the sheathing panels extending beyond the edges of the layer of insulating material to provide a first channel along at least one edge of the panel structure;
(ii) preparing a second panel structure comprising two second sheathing panels and a second layer of insulating material therebetween, the layer of insulating material being secured to both of the sheathing panels, and the edges of the sheathing panels extending beyond the edges of the layer of insulating material to provide a second channel along at least one edge of the panel structure;
{iii} locating a beam of timber into both of the first channel and the second channel and moving the first panel structure and second panel structure together so that edges of both first sheathing panels and both second sheathing panels overlie the beam of timber; and
(iv) inserting a line of wide crown staples through the sheathing panels and into the beam of timber, the staples each having a first leg and a second leg, the first leg passing through a first sheathing panel and into the beam of timber and the second leg passing through a second sheathing panel and into the beam of timber.

12. A method according to claim 1 or claim 11 in which the leading ends of the staples are shaped so that the legs of the staples are forced out of parallel upon entry into the sheathing and beam material.
